(19) United States
(12) Patent Application Publication
(10) Pub. No.: US 2015/0248643 A1
(43) Pub. Date: Sep. 3, 2015

(54) SYSTEMS AND METHODS FOR GENERATING PROJECT PLANS FROM PREDICTIVE PROJECT MODELS

(71) Applicant: Align Matters, Inc., Los Angeles, CA (US)

(72) Inventor: Alan Nathanson, Los Angeles, CA (US)

(73) Assignee: Align Matters, Inc., Los Angeles, CA (US)

(21) Appl. No.: 14/427,164

(22) PCT Filed: Sep. 12, 2013
(86) PCT No.: PCT/US13/59449

§ 371 Date: Mar. 10, 2015

Related U.S. Application Data
(60) Provisional application No. 61/700,139, filed on Sep. 12, 2012.

(51) Int. Cl. G06Q 10/10; G06F 3/0482; G06Q 10/06; G06F 3/0484

(52) U.S. Cl. CPC G06Q 10/103; G06F 3/04842; G06F 3/0482; G06Q 10/0635; G06Q 10/0637; G06Q 10/067

(57) ABSTRACT

Systems and methods are disclosed for generating project plans from project models. In some aspects, a project application can provide a graphical interface responsive to receiving a request to generate a project plan for an organization from a project model. The project application can generate the graphical interface based on the selected project model. The graphical interface can include sections for selecting criteria, such as organizational objectives and risk management factors for the project plan. The project application can select at least one organizational objective and at least one risk management factor based on input received via the graphical interface. The project application can determine a baseline risk associated with the organizational objective and a modification of the baseline risk associated with the risk management factor.

This disclosure relates generally to computer software and more particularly relates to generating project plans from project models based on an organization's objectives and risk profile.

### BACKGROUND

Organizations such as businesses, legal firms, and other entities may undertake projects for the purpose of achieving a desirable outcome for the organization. In many instances a desirable outcome is one that provides the best business outcome. A project plan may include various components such as desired outcomes, budgeting and time constraints, tasks to be performed, assignments of tasks to personnel, etc. Systems and methods are desirable for creating customized plans and for managing the execution of the plans by integrating the various components and thereby improving the efficiency of the process.

### SUMMARY

Systems and methods are disclosed for generating project plans from project models. An exemplary method involves providing a graphical interface in response to receiving a request to generate a project plan from a selected project model for an organization. The graphical interface is generated based on the project model. The graphical interface can include sections for selecting criteria for the project plan, such as organizational objectives and risk management factors. The method also involves selecting at least one organizational objective and at least one risk management factor in response to input received via the graphical interface. The method also involves determining a risk associated with the at least one organizational objective and a modification of the risk associated with at least one risk management factor based on the project model. The method also involves updating the graphical interface to include a composite risk associated with the project plan, wherein the composite risk is generated for the project plan based on the risk, the modification of the risk, the risk profile for the organization, and the project model.

These illustrative aspects and features are mentioned not to limit or define the invention, but to provide examples to aid understanding of the concepts disclosed in this application. Other aspects, advantages, and features will become apparent after review of the entire application.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram depicting an example of a system architecture for generating project plans from project models;

FIG. 2 is a block diagram depicting exemplary processes for generating a project plan from a project model and managing the execution of the project plan.

FIG. 3 is a diagram depicting an example of a graphical interface provided by a project application for selecting or otherwise inputting project objectives and criteria for a project plan;

FIG. 4 is a diagram depicting the graphical interface of FIG. 3 after receiving inputs selecting one or more organizational objectives for a litigation project;

FIG. 5 is a diagram depicting the graphical interface of FIG. 3 after receiving inputs selecting criteria related to impacts of the litigation project on the organization;

FIG. 6 is a diagram depicting the graphical interface of FIG. 3 after receiving inputs related to damages estimates for the litigation project;

FIG. 7 is a diagram depicting the graphical interface of FIG. 3 after receiving inputs selecting risk management factors for the litigation project;

FIG. 8 is a diagram of an example of a graphical interface used to generate a risk profile for a company or other organization via the project application;

FIG. 9 is a diagram depicting the graphical interface of FIG. 8 after receiving inputs adding primary risks;

FIG. 10 is a diagram depicting the graphical interface of FIG. 8 after receiving inputs modifying weighting for primary risks; and

FIG. 11 is a flow chart illustrating an example method for obtaining risk information associated with a project plan generated from a project model.

### DETAILED DESCRIPTION

Systems and methods are provided for generating project plans from project models. A customized project plan for a specific project or matter is created based on a project model for a type of project, objectives and criteria specific to the organization undertaking the project, and information specific to the project. Some aspects of the invention provide an interactive process for the user creating the plan to assess the impact of the selection of specific objectives and/or criteria on the results to be achieved from the plan. For example, indicators for project attributes, such as cost, liability, margins and risk, may reflect the impact of selections made or changed. Risk may also be based on the organization's specific risk profile.

Once a project plan is created, it may be used to control and evaluate the execution of the project plan on an on-going basis in a more integrated and complete manner than is presently possible. As project plans are executed, data is collected and may be used to refine the project models.

In accordance with some aspects, a project application can provide a graphical interface responsive to receiving a request to generate a project plan. The project application can generate the graphical interface based on a project model selected by an organization from a library of project models. The graphical interface can include sections for selecting objectives and criteria, such as organizational objectives and risk management factors, for the project plan. The objectives and criteria presented are defined by the project model. The project application can select at least one organizational objective and at least one risk management factor in response to input received via the graphical interface. The project application can determine a risk associated with the objectives and criteria and update the graphical interface to provide a risk indicator.

As used herein, the term “project model” is used to refer to a model that is used to generate a project plan. A project model may specify components, such as a critical path for the project, one or more teams involved in the project, one or more roles for the team(s), milestones for the project, time requirements for completing tasks associated with the project, a budget for the project, assignment work times, business criteria for the project, risks associated with the project, and business margins for the project. A project model can be designed for specific types of projects (e.g., patent litigation, antitrust litigation, highway construction, etc.), specific industries and/or professions, etc. Senior professionals or subject matter experts can access existing project models or project model components via a project application to create project models. Alternatively, the generation of project models can be achieved through crowd sourcing.

As used herein, the term “project plan” is used to refer to a plan for performing one or more tasks or groups of tasks to achieve one or more predetermined objectives for a particular project. In some aspects, a project plan can include a schedule or other associated timeline having a defined beginning and end. A project plan can include objectives, tasks to perform the objectives, a schedule, one or more constraints (e.g., time, funding, etc.), one or more personnel assigned or otherwise identified to perform tasks for the project, etc. In some aspects, a project plan can include a sequence of planned tasks for achieving one or more objectives of the project and the earliest and latest that each activity can start and finish without increasing the overall time required for completing the project. A critical path can be determined from a list of tasks required to complete at least one objective for the project, a respective duration for each activity, dependencies between activities, etc. The project application can be used to generate project plans for any project-driven industry or profession. Non-limiting examples of such industries and professions include the legal profession, the medical profession, the construction industry, the retail industry, etc. While a project model may define a task as taking a certain amount of time or a team as including people with particular skill sets or experiences, a project plan identifies a specific start and end date for the task and specific individuals for the team.

As used herein, the term “organization” is used to refer to an entity including one or more individuals organized for working collectively to achieve one or more common goals. Non-limiting examples of an organization include business entities (e.g., small businesses, partnerships, sole proprietorships, corporations, etc.), government entities (e.g., government agencies, legislative bodies, military units, etc.), non-profit organizations, etc.

As used herein, the term “organizational objective” is used to refer to a desired outcome for an organization that directly or indirectly furthers one or more goals of the organization. Examples of organizational objectives are improving profit margins, enhancing customer satisfaction, increasing market share, etc. In the context of a legal matter, an organization may create a project plan for a patent infringement lawsuit to enforce a patent owned by the company to increase its market share by inhibiting a competitor.

As used herein, the term “risk” is used to refer to the possibility of an undesirable outcome resulting from one or more actions that directly or indirectly causes one or more negative impacts to one or more goals of the organizations.

As used herein, the term “composite risk” is used to refer to a risk determined based on multiple risks, multiple factors associated with a given risk, and/or risks as mitigated by risk management factors for a particular project as defined by the underlying project model. In one non-limiting example, a composite risk may be determined based on multiple factors associated with a given risk such as the likelihood of an undesirable outcome occurring and a severity of the negative impact associated with the risk for an organization. The severity of the negative risk may be based on the organization's risk profile. In another non-limiting example, a composite risk for an organization may be determined based on both the risks associated with a given action and a mitigation or other modification of the risk associated with a risk management factor. A composite risk may be expressed using a relative indicator, such as color, a position on a slider, or a number, where increased or decreased risk is expressed by a change to the relative indicator.

As used herein, the term “risk management factor” is used to refer to actions or other considerations that can mitigate or otherwise modify a risk associated with an action.

These illustrative examples are given to introduce the reader to the general subject matter discussed here and are not intended to limit the scope of the disclosed concepts. The following sections describe various additional aspects and examples with reference to the drawings in which like numerals indicate like elements.

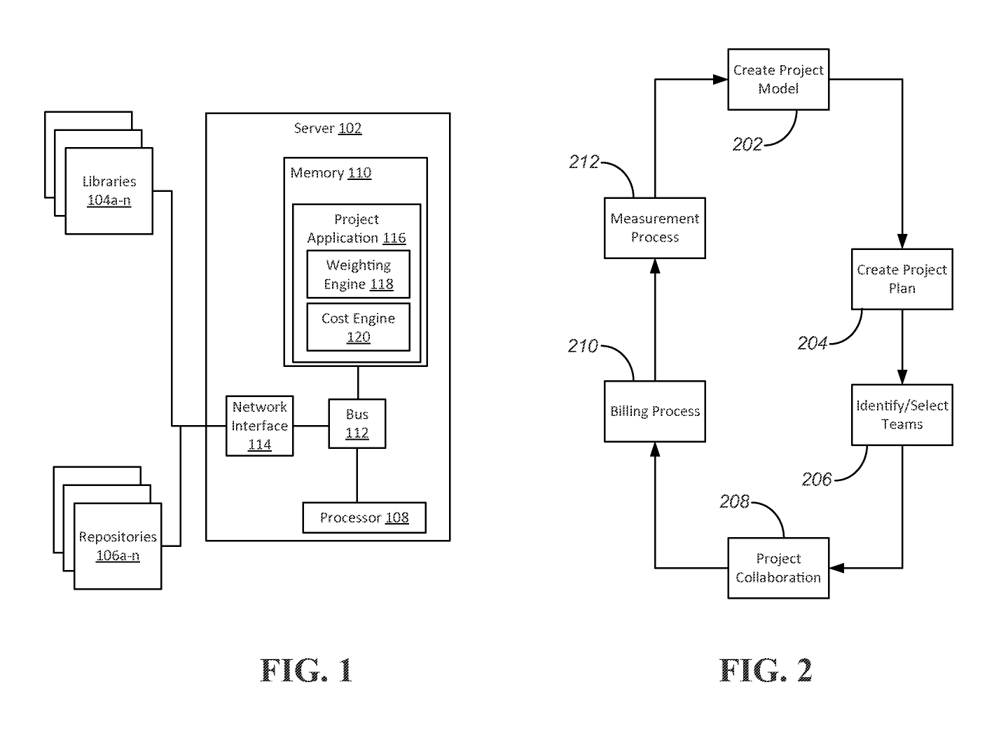

Referring now to the drawings, FIG. 1 is a block diagram depicting an example of a system architecture for generating project plans from project models. The system architecture can include a server 102, one or more libraries 104a-n, and one or more repositories 106a-n. The system illustrated in FIG. 1 may be connected to and accessed by other systems via a network, such as the Internet.

The server 102 can include a processing device 108. Non-limiting examples of the processing device 108 include a microprocessor, an application-specific integrated circuit (“ASIC”), a state machine, or other suitable processing device. The processing device 108 can include any number of processing devices, including one. The processing device 108 can be communicatively coupled to computer-readable media, such as memory device 110. The processing device 108 can execute computer-executable program instructions and/or accesses information respectively stored in the memory device 110.

The memory device 110 can store instructions that are executable by the processing device 108 to cause the processing device 108 to perform operations described herein. The memory device 110 may be a computer-readable medium such as (but not limited to) an electronic, optical, magnetic, or other storage device capable of providing a processor with computer-readable instructions. Non-limiting examples of such optical, magnetic, or other storage devices include read-only (“ROM”) device(s), random-access memory (“RAM”) device(s), magnetic disk(s), magnetic tape(s) or other magnetic storage, memory chip(s), an ASIC, configured processor(s), optical storage device(s), or any other medium from which a computer processor can read instructions. The instructions may comprise processor-specific instructions generated by a compiler and/or an interpreter from code written in any suitable computer-programming language. Non-limiting examples of suitable computer-programming languages include C, C++, C#, Visual Basic, Java, Python, Perl, JavaScript, ActionScript, and the like.

The server 102 can also include a bus 112 that can communicatively couple one or more components of the server 102 and a network interface device 114.

In some aspects, one or more of the libraries 104a-n and the repositories 106a-n can be stored at a data source remotely accessible by the server 102 via a data network using the network interface device 114. In other aspects, one or more of the libraries 104a-n and the repositories 106a-n can be stored in the memory device 110 of the server 102.

The libraries 104a-n can include project models and components of project models. For example, legal project models can be generated for litigation matters by accessing libraries describing possible phases in a case, organizational objectives associated with litigation matters, risks involved in legal matters, teams to be assigned to legal matters, roles of various team members, etc. The libraries 104a-n can be used to provide guidance to a project model author in developing a project model. For example, a library may describe a component for a litigation phase such as “Commencement of Litigation.” A project model author can select the “Commencement of Litigation” component from the library. The project application 116 can suggest that “Commencement of Litigation” generally precedes a “Case Assessment” phase for a “Patent Troll” matter or that “Commencement of Litigation” generally follows a “Case Assessment” phase for an ERISA litigation matter. The project application 116 can provide guidance to the project model author describing how to make a choice when using an item from a library to create a project model.

In a non-limiting example, legal project models may be categorized and maintained in libraries 104a-n such as libraries for litigation, transactional and regulatory compliance models. Legal project models may be created for specific country laws (e.g., U.S., U.K. Canada, Australia, Korea, Singapore, Philippines, etc.). In some aspects, project models can be created using the language for the target country. The project application 116 may provide translations so that a model created in a first language may be used to create a plan in a second language. A project model in the litigation, transactional or regulatory library may be associated with 1) a type, 2) a jurisdiction, 3) a sub jurisdiction (optional), and 4) a primary party. For example, a project model for “Patent Litigation Plaintiff (US)” has a type of litigation, a jurisdiction of US, and a primary party of plaintiff. The model does not have a sub-jurisdiction since the model is related to federal law. If the project model involved state law, then the sub jurisdiction would be the applicable state. If a new project model for “Patent Litigation Plaintiff (Korea) is created, then the litigation library is extended to include this new model.

Each element in the project model library is coded and the same code is used across jurisdictions and languages For example, the code for “Case Assessment” is the same for a project model for Canada as a project model for the U.S.

The libraries 104a-n may also include a business objectives library and a risk management factors library. The business objectives and risk management factors may be associated with multiple project models and multiple types of project models. The repositories 106a-n can include data used to populate one or more default values in generating project models. For example, for a project model describing a legal matter, repositories 106a-n can include a database for rates for various jurisdictions. A project model author can complete a table of fee rates for a model using data that includes rates from the international jurisdiction rates table. As project plans based on the model are executed, actual rate information is collected by the system and may be used to update the rates for the model and/or the rates table.

The repositories 106a-n can also include data used to select or otherwise generate teams for a project. For example, a user can execute the project application 116 to select teams from a “Teams” table to generate a legal project model. Non-limiting examples of teams for legal projects may include in-house counsel, outside counsel, lead counsel, co-counsel, damages expert, underwriter, etc. The repositories 106a-n can also include data used to identify roles in a project. Non-limiting examples of roles may include assistant general counsel, partner, senior associate, arbitrator, subject matter experts, investment bankers, etc.

The repositories 106a-n can also include data collected during execution of project plans. The data is associated with the relevant aspect of a project plan so that data collected from the execution of different project plans created using the same project model can be identified. The data may also be associated with a relevant entity, such as a particular individual, so that the data for that entity can be identified across multiple project plans.

FIG. 1 also depicts a project application 116 stored to the memory device 110. The project application 116 can generate or be used to generate project plans from project models. The project application 116 can include a weighting engine 118 and a cost engine 120.

The weighting engine 118 can evaluate and weight risks associated with a project plan. For example, the weighting engine 118 can generate a composite risk associated with a legal project for an organization based on the project model, the objectives and criteria provided, and the risk profile for the organization. The weighting engine 118 can also provide an interface to allow an organization to create or modify its risk profile.

The cost engine 120 can perform one or more cost algorithms to assign values to cost items (e.g., damages estimates, future claims estimates, etc.). The cost engine may also support operations related to budget and costs, such as providing alerts if a budget threshold is reached and billing and payment processes.

FIG. 2 is a diagram depicting processes involved in generating a project model, generating a project plan from a project model, and executing the project plan.

In a non-limiting example, a project model is created at 202. The project model may be created by a subject matter expert using existing models or model components available from repositories 106a-n or components provided by the subject matter expert. Typically a project model is directed to a type of project and is intended to be used to create multiple project plans for multiple projects and multiple organizations. Examples of project models include “Patent Litigation Plaintiff (US)”, Patent Litigation Defendant (US), “Acquisition of US Company Using Securities”, and “Acquisition of US Company Using Cash”.

The project application 116 can provide a model author with a sequenced set of modules that guide an approach for a model, assist in selecting the right teams, and define potential project outcomes. A project model can include phases, tasks, task assignments, timeline milestones, and task codes. Task codes can define phases, tasks, task assignments and timeline milestones. The project model can also include resource levels for respective task assignments. A resource level can include a cost and a time for completing the task assignment. The project model can also include alternate resource and effort definitions. Alternate resource and effort definitions can be generated by embedding lower and/or higher skill levels with respective time allocations. The project application 116 can automatically provide cost and/or time requirements based on the alternate resource and effort definitions.

A project plan for a specific organization and a specific project is created at 204. A user selects a project model and then provides inputs related to the objectives and criteria for the project. The user is associated with an organization. Prior to the selection of a project model, the user or another representative of the organization completes a profile for the organization, including a risk profile for the organization. The organization's profile may include business information, such as margins or revenue, as well as business rules, such as requirements for outside counsel and allowed budget overage. Information from the organization's profile is used by the project model to help guide the user in building a project plan. The project application 116 may provide feedback to the user to show how certain selections or changes impact attributes of the plan, such as cost and risk. Although the project model defines every possible element of the plan, such as action, risk, budget, etc., the user is only prompted to provide inputs related to business objectives, risk management factors, and team members. In this manner, the project application shows the user how the selected criteria impacts the business attributes. Once the user completes the entry of the objectives and the criteria, a project plan is created. The project plan includes tasks, budgets, schedules, teams and roles. The user may modify a project plan by removing, reordering, or otherwise modifying phases, tasks, timelines, or milestones.

Additional details for the team members are collected at 206. In the example of a litigation matter, the selection of teams may include the selection of in-house counsel, outside counsel, experts and/or consultants. If the project plan is the subject of a request for proposal, then multiple recipients may be specified at 206 and the plan provided to each of them. Each recipient may review the plan and provide details about plan implementation, such as identifying the specific individuals that would perform certain tasks. A recipient may also suggest changes to the plan. For example, a recipient may suggest moving a task to a later time, eliminating a task, or adding a task. A recipient may also suggest a team member with a different skill set or level of experience than specified by the plan. Upon receipt of the proposals, the user or its designee may determine which recipient to select to implement the project plan. If the selected recipient suggested changes to the project plan, the user also determines whether to accept the changes. If the changes are accepted, then the project plan is modified accordingly. Once the recipient is chosen and the project plan is set, execution of the plan can begin.

The project application can automatically establish or otherwise provide an integrated communication environment for the multiple individuals or other entities involved in a project plan at 208. The integrated communication environment can include one or more applications, actions, or other processes used to facilitate communication among individuals or other entities involved in a project. In a non-limiting example, an integrated communication environment can include shared planning applications, shared calendar applications, shared budgeting information, etc. Automatically providing an integrated communication environment for multiple entities can eliminate barriers between the various entities involved in a legal matter or other project.

Billing for the project is handled at 210. If the parties are using an external electronic billing system, then the cost engine provides the necessary information to the billing system including but not limited to budget information and incurred cost information.

Evaluation of the performance of the project plan is ongoing and is shown as measurement process 212. By measuring all aspects of the project plan performance as the plan is executed, any deviations or anomalies can be quickly flagged and corrected before they become an obstacle to completion of the plan on time and on budget or to the project's objectives. The data collected during the execution of the plan may be used to make or suggest changes to the project model or to future project plans.

In some aspects, the project application 116 can monitor for trends and anomalies in similar projects to refine project models and/or existing project plans. For example, in a legal context, the project application 116 can learn or otherwise receive information that many project plans modify a particular component for the generated plan. If so, then the project application can notify the author of the model or an administrator, modify the project model, or alert users of the potential alternative. If the modification is one that is specific to an industry or jurisdiction, then the project application may create an industry-specific project model or only modify the project model for that jurisdiction.

In one aspect of the invention, the project application 116 supports multiple organizations. The data collected during the execution of the project plans can be used to modify project models, update repositories, or otherwise be available so that one organization can benefit from the experiences of other organizations that have used the system. In one exemplary system, changes to a model are automatically made based on certain thresholds, such as changing a model if project plans using the model have been executed a certain number of times and the potential change has been made in a certain percentage of the projects. For example, for the first 10 uses of the project model, if the project model has been used at least 5 times and 100% of the projects made the change, then the system changes the model. For subsequent changes, if the project model has been used between 11 and 20 times and 75% of the projects made the change, then the system changes the model. If the project model has been used over 21 times and 50% of the projects made the change, then the system changes the model. The collected data may also be analyzed to provide insights into multiple projects for a single organization or to generate industry benchmarks.

A potential change to the model is considered so long as the goals and objectives of the project plans are met. For example, a project model assigns a partner to perform a particular assignment. The project model is used to create 20 different project plans. In 18 of the plans a senior associate performs the assignment instead of a partner and the goals and objectives of the plan are still met. In this example, the project model will be modified to assign the assignment to a senior associate, which will then cause a change in the budget to reflect the different level of team member.

The types of changes to the model include changes to criteria, such as adding, deleting, or naming; changes to teams, such as adding, deleting, or naming; changes to assigned roles, such as less seniority or more seniority; changes to phases, task, and assignments, such as adding, or deleting; changes to scope, such as trigger; changes to time allocations, such as increasing or decreasing; and changes to milestones, such as adding, deleting or renaming; and changes to the critical path, such as adding or deleting an item from the critical path.

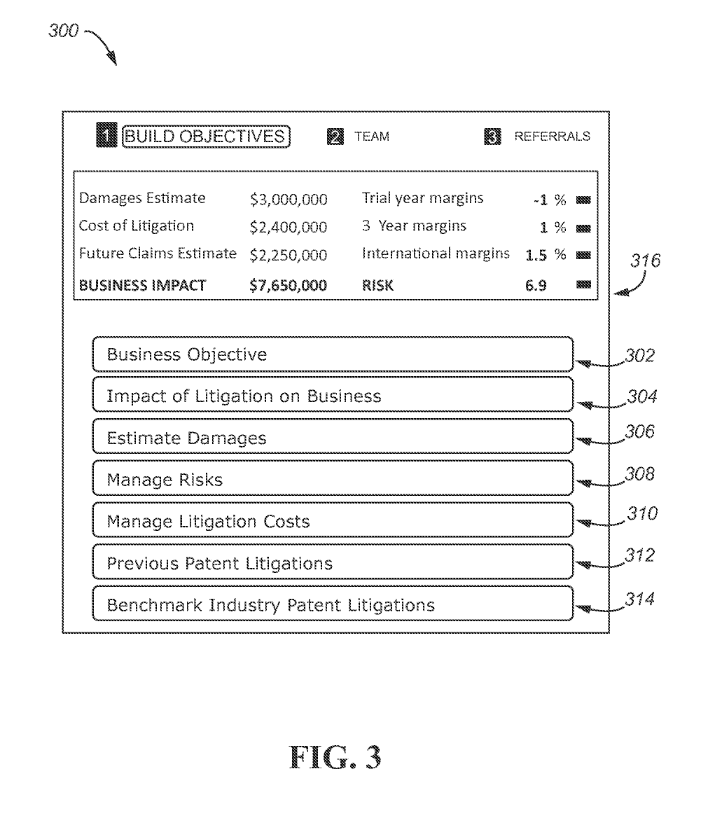

FIG. 3 is an example graphical interface 300 provided by the project application 116 for selecting or otherwise inputting project objectives and criteria for creating a project plan once the user has selected a project model for Patent Litigation-Plaintiff (US). The graphical interface 300 can display attributes of a project such as costs and impacts on a company or other organization. For example, FIG. 3 depicts a graphical interface 300 for a project such as a litigation matter. Attributes of a litigation matter can include costs such as a damages estimate, a cost of litigation, and a future claims estimate. Attributes of a litigation matter can also include organization impacts such as trial year margins, three-year margins, international margins, a risk associated with the matter, etc. In some instances the attributes are based, in part, on information from the organization's profile, such as current margins, revenues, budget, etc. Selections of project objectives and criteria can cause changes in a visual indicator or other feedback output in the graphical interface that provides a user with guidance on the impact of a selection. Exemplary feedback indicators include color (red-yellow-green), up or down arrows, positions on a slider, relative numeric values, etc.

The graphical interface 300 can include sections 302, 304, 306, 308, 310, 312, 314, 316. Section 302 can be configured to receive inputs selecting, inputting, or otherwise identifying business objectives. Section 304 can be configured to receive inputs selecting, inputting, or otherwise identifying litigation impacts on the business or other organization. Section 306 can be configured to receive inputs selecting, inputting, or otherwise identifying estimates of damages for the litigation matter. Section 308 can be configured to receive inputs selecting, inputting, or otherwise identifying risk management factors for the litigation matter. Section 310 can be configured to receive inputs selecting, inputting, or otherwise identifying factors for managing costs associated with the litigation matter. In some instances the inputs for section 310 are specified in the organization's profile. If the organization has certain litigation requirements that apply to all litigation projects for the organization, then they may be included in the organization's profile and used as inputs for section 310. For example, there may be requirements related to pre-approval of all team members, to only using team member with a minimum level of experience, or to approving only a certain number of depositions. Section 312 can be configured to receive inputs selecting, inputting, or otherwise identifying previous patent litigation matters. Section 314 can be configured to receive inputs selecting, inputting, or otherwise identifying patent litigation matters for a benchmark industry. Section 316 can be configured to display outputs and/or other visual indicators for a damages estimate, a cost of litigation, and a future claims estimate, trial year margins, three-year margins, international margins, and a composite risk associated with the litigation matter.

The project model specifies the presentation of the specific objectives and criteria. Different models will present different options to the user. The project models are designed to elicit information from the user that will assist the user in creating a project plan to meet the user's goals. The sections of graphical interface 300 are presented for illustrative purposes. In additional or alternative aspects, a graphical interface 300 can include other sections specific to different project types, industries, professions, organizations, etc.

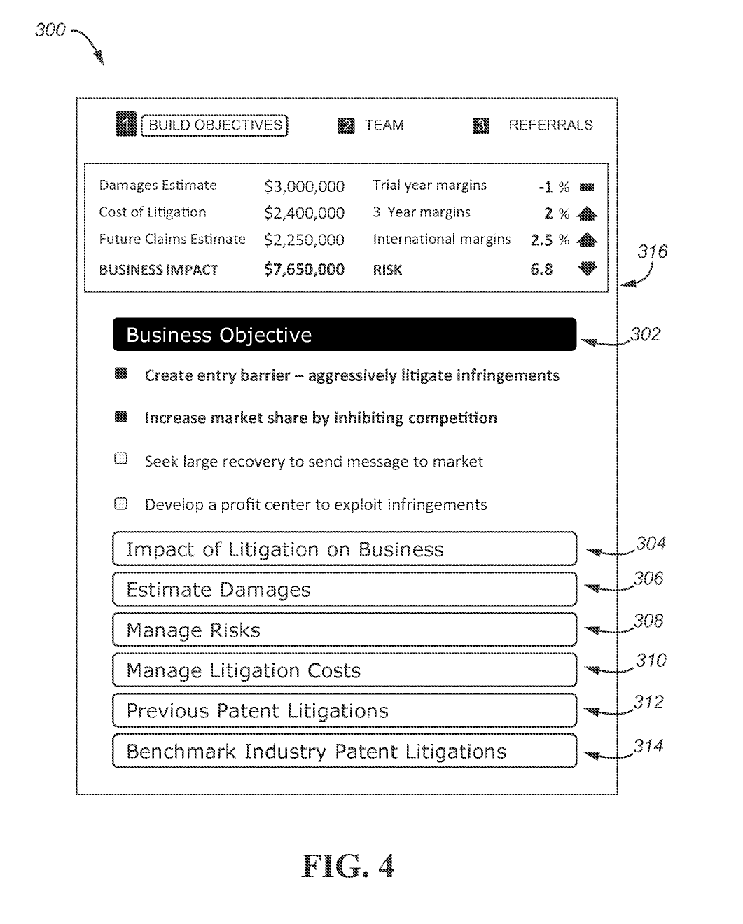

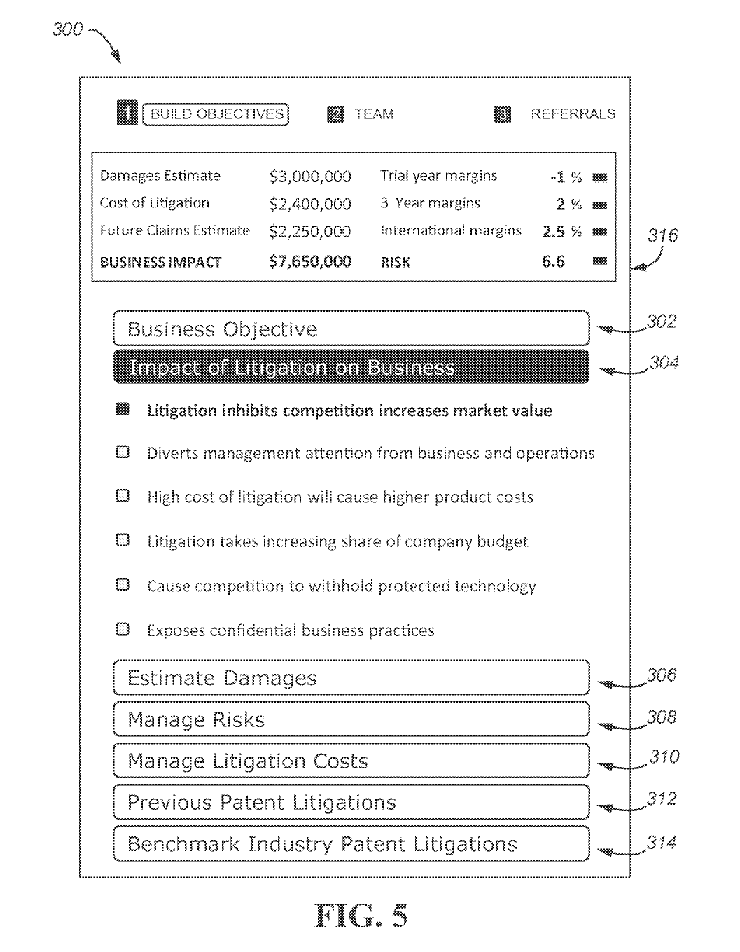

The project application 116 can modify attributes of a litigation matter or other project based on input received via the graphical interface 300. For example, FIG. 4 depicts the graphical interface 300 after receiving input to section 302 for selecting or otherwise identifying one or more organizational objectives for the project. A list of organizational objectives can be selected for display in the graphical interface 300 based on a model associated with a project. For example, a project model for a patent litigation matter may include organizational objectives such as creating an entry barrier for competitors by aggressively litigating infringements, increasing market share by inhibiting cooperation, seeking large recoveries to send a message to the relevant market, and developing a profit center to exploit infringements. One or more of the business objectives can be selected via the graphical interface 300. For example, FIG. 4 depicts a selection of organizational objectives such as creating an entry barrier for competitors by aggressively litigating infringements and increasing market share by inhibiting cooperation can increase the three-year and international margins and decrease the risk associated with the matter.

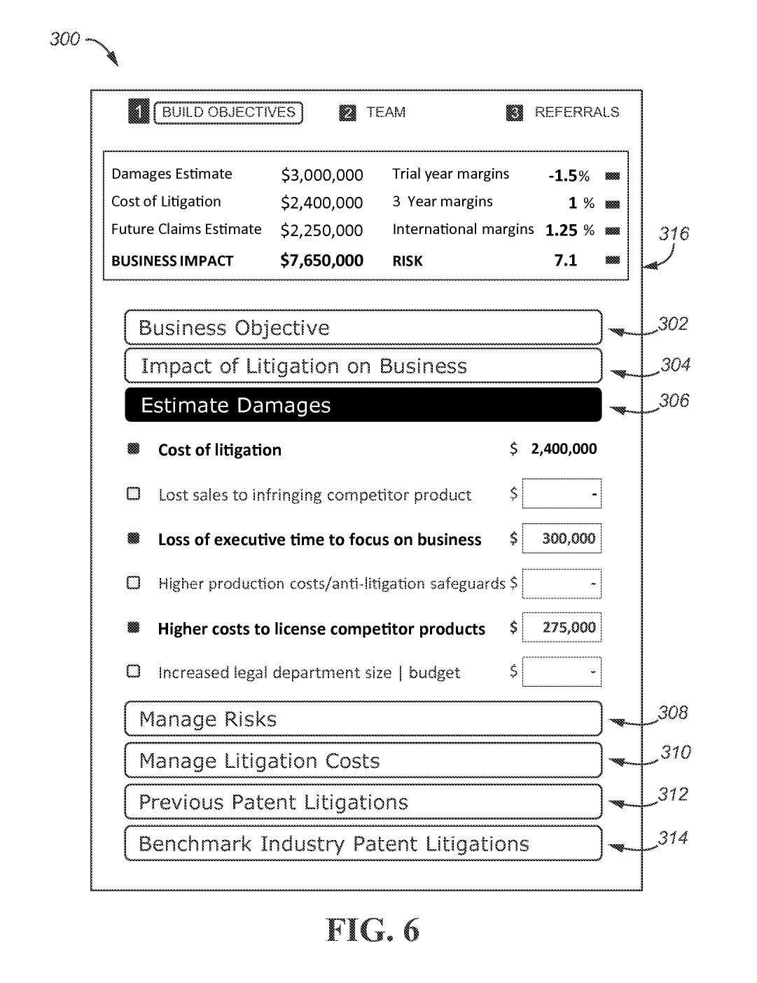

Selecting one or more organizational objectives can cause the project application 116 to modify one or more attributes. For example, identifying the relevant organizational objectives for the project via graphical interface 300 may decrease the composite risk associated with the project from 6.9 (as depicted in FIGS. 3) to 6.8 (as depicted in FIG. 4). In this example, the composite risk is expressed on a 0-10 scale. The graphical interface 300 can also be used to further specify the criteria used to generate the project plan and thereby modify the risk associated with the project, as depicted in FIGS. 5-6. For example, FIG. 5 depicts receiving inputs to section 304 for criteria related to a litigation impact on the business to inhibition of competition and increase in market value. The selection depicted in FIG. 5 may decrease the composite risk associated with the project from 6.9 (as depicted in FIGS. 4) to 6.6 (as depicted in FIG. 5). FIG. 6 depicts receiving inputs to section 306 for criteria used for damages estimates for factors such as cost of litigation, loss of executive time to focus on business, and higher cost to license competitor products. The selection depicted in FIG. 6 may increase the composite risk associated with the project from 6.6 (as depicted in FIGS. 5) to 7.1 (as depicted in FIG. 6).

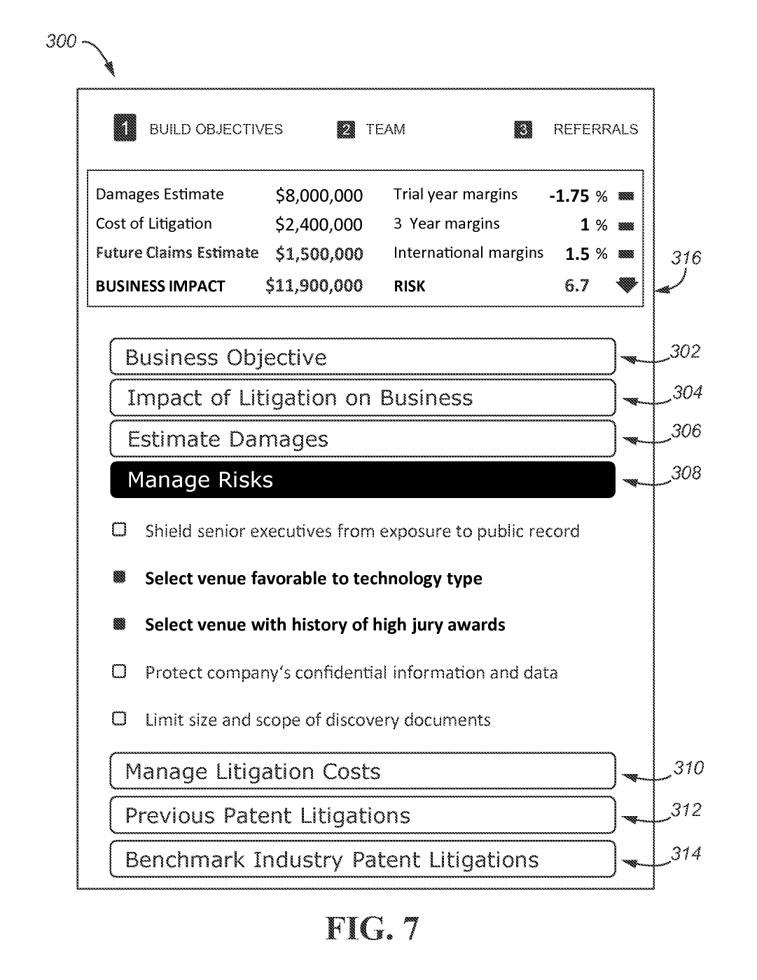

The graphical interface 300 can also be used to select criteria or factors related to risk management. For example, FIG. 7 depicts a selection of risk management factors via the graphical interface 300. Input can be received to section 308 to select one or more risk management factors, such as (for example), selecting venues favorable to a technology at issue in a patent litigation matter, selecting venues with histories of high jury awards in patent litigation matters, etc. The project application 116 can update one or more visual indicators in section 316 based on selection input received to section 306. For example, as depicted in FIG. 7, selection of risk management factors can cause the composite risk to be decreased to 6.7.

Additional objectives and criteria may be entered under sections 310, 312, and 314 and may also impact the attributes of the project plan. Examples of the criteria that can be specified under section 310 include those related to preapproval of team members, number of depositions, document review methods, etc.

Once the user has completed the objective and criteria entry, the project application 116 generates a project plan. The user may then proceed to build a team to execute the plan. As discussed above, the building of a team may include members from within the organization and outside the organization and may include a request for proposal process. The selection of the team may also impact the composite risk or any of the other attributes. For example, past results or experience of the business unit team members may impact the margins and/or composite risk and past results or experiences of the legal team members may impact the cost of litigation, damages and/or composite risk. Exemplary team information that is solicited for the example of a patent litigation matter may include business unit team members, in-house legal team members, lead counsel (e.g., outside counsel), document review team members, eDiscovery team members, consultants, and experts.

In one aspect, the project application 116 can provide referrals or suggestions to the user for outside counsel. The project application 116 identifies potential referrals based on how well the past results and/or experiences of the potential referral match up with the specified objectives and criteria.

The composite risk shown in the graphical interface of FIGS. 3-7 is based on the project model, the objectives and criteria entered by the user, and the organization's risk profile. The project model can associate or be used to associate a risk value to one or more aspects of a project, such as task assignments, team members or other resources, organizational objectives, etc. In one non-limiting example, the project model can assign a higher risk value if a lower-skill resource is selected, such as a team member having a lower amount of experience in the relevant industry. Assigning a less experienced team member to perform a task can cause the assigned task to be weighted more heavily with respect to the risk associated with the project. Assigning a less experienced team member to perform a task can also cause the other project tasks dependent on the assigned task to be weighted more heavily with respect to risk associated with the project.

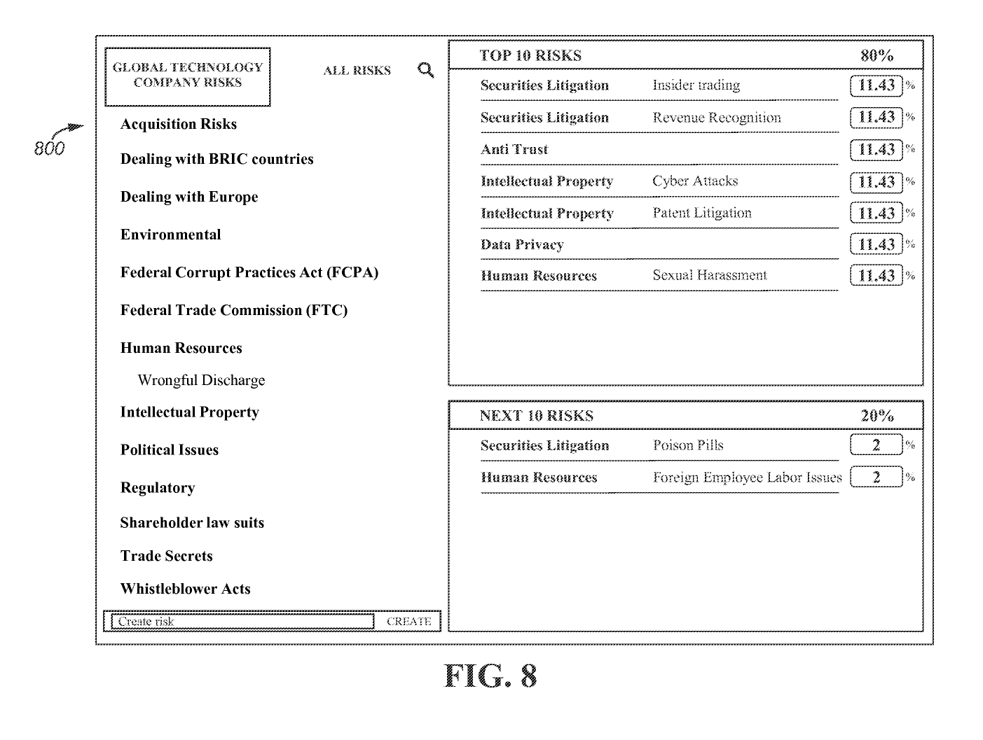

A risk profile for the company or other organization can be based on a set of risks. For example, FIG. 8 is a diagram of an example graphical interface 800 used to generate a risk profile for a company or other organization via the project application 116. A risk profile for a company or other organization can include risks identified by the organization as primary risks, secondary risks, and other risks. An item being included as a primary risk in a risk profile can indicate that the company or other organization is highly sensitive to the risk associated with the item.

The primary risks can be identified as the “Top 10 Risks” in the graphical interface 800. For example, a company or other organization can identify primary risks such as securities litigation matters involving insider trading and revenue recognition, antitrust matters, intellectual property matters involving cyber-attacks and patent litigation, data privacy matters, and human resources matters involving sexual harassment. The secondary risks can be identified as the “Next 10 Risks” in the graphical interface 800. For example, a company or other organization can identify secondary risks such as securities litigation matters involving poison pills and human resources matters involving foreign employee labor issues. Other risks are not shown in FIG. 8.

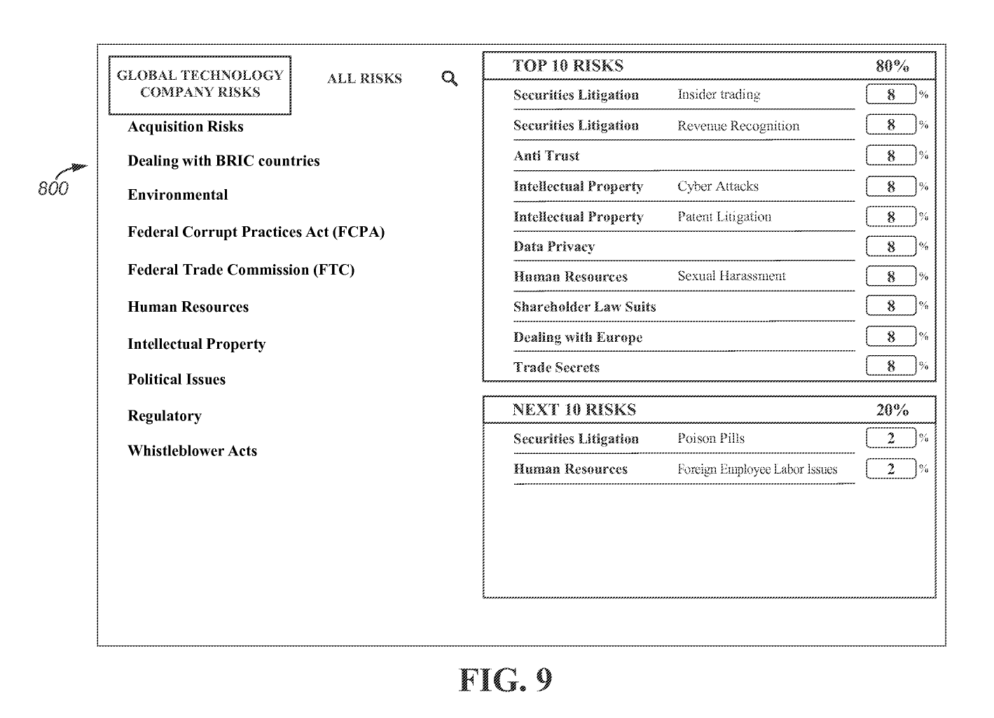

Primary risks can be weighted more heavily than secondary risks. For example, the ten highest risks can be assigned to 80% of the risk profile for a company or other organization. In some aspects, the project application 116 can automatically allocate the risk awareness evenly among the primary risks by default. For example, FIG. 8 depicts seven primary risks, each of which are respectively assigned 11.43% of risk awareness. Adding additional risks to the set of primary risks can cause risk awareness to be re-allocated with respect to the primary risks. For example, FIG. 9 depicts the graphical interface 800 with three risks added to the set of primary risk. Each primary risk is respectively assigned 8% of risk awareness.

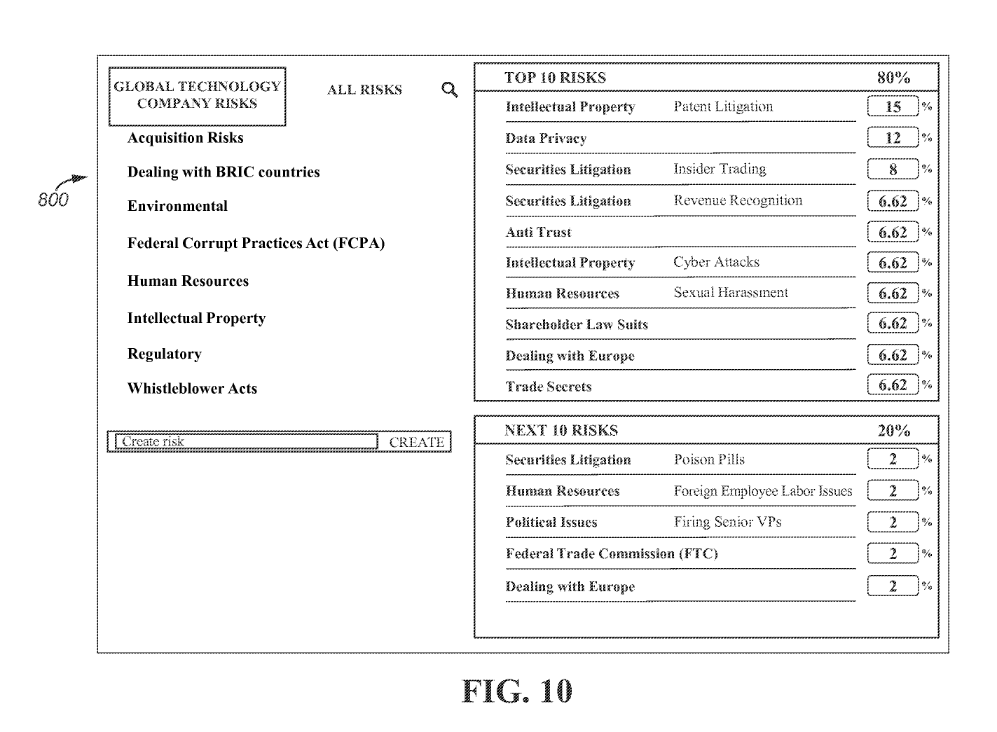

In some aspects, the various primary risks can also be differently weighted with respect to one another. The project application 116 can receive input modifying the allocation of risk awareness among risks. For example, FIG. 10 depicts the risk awareness associated with patent litigation and data privacy being increased to 15% and 12%, respectively. The risk awareness for insider trading matters can be set to 8%. The risk awareness can be allocated automatically to the remaining primary risks such that 6.62% of risk awareness is allocated for each remaining primary risk).

A lower proportion of the risk awareness for a company or other entity can be assigned to secondary risks. For example, as depicted in FIGS. 8-10, 20% of the risk awareness for a company or other organization can be allocated to the “Next 10 Risks” (i.e. secondary risks). Each secondary risk can be weighted less heavily than the lowest-weighted primary risk. For example, FIG. 10 depicts that the lowest weight for a primary risk is 6.62%. The project application 116 can restrict modifications to the weights for the secondary risks such that each secondary risk has a weight less than or equal to 6.62%.

Each possible risk is associated with one or more project models based on the model's type or jurisdiction. For example, the “Intellectual Property—Patent Litigation” risk is associated with all project models related to patent litigation regardless of jurisdiction and the “Dealing with Europe” risk is associated with all project models related to Europe or any country within Europe regardless of whether the model is litigation, transactional or regulatory compliance.

Since composite risk is based, in part, on an organization's risk profile, composite risk will differ for different organizations for similar projects if the organizations' risk profiles differ.

The risks depicted in FIGS. 8-10 are described for illustrative purposes only. In additional or alternative aspects, the project application 116 can generate or be used to generate risk profiles using other types of risks or for other types of organizations.

Recently created project plans can be compared against a risk profile for the company or other organization to validate the risk profile. The project application 116 can automatically generate a report and transmit the report to the general counsel or other appropriate entity for a company or other organization. The general counsel or other appropriate entity can also access risk profiles for the company or other organization using the project application 116. The general counsel or other appropriate entity can use the project application 116 to generate reports and/or modify the risk profile for the company or other organization. For example, a general counsel can use the project application 116 to generate a report for specific risk categories, specific matters, specific business units, etc. of a company and then modify the company's risk profile by reclassifying a risk or modifying a risk weighting.

The project application 116 uses the organization's risk profile, including the weightings, along with the selected business objectives and the project model to generate a baseline composite risk for the project plan. The project model defines the business objectives associated with the model and for each business objective defines the risk management factors associated with the business objective and a weight for each of the risk management factors. In one example, a project plan defines 10-15 risk management factors for each business objective. Once the user enters the business objectives, as shown in FIG. 4, the project application 116 can generate the initial composite risk. As the user selects other criteria, such as those under sections 304-308, the project application uses the selected criteria to modify the initial composite risk based on the project model and the additional criteria.

The project model may also associate a risk management factor with one or more specific tasks, teams, schedule items and/or budget items so that a modification of any of these elements modifies the composite risk.

As discussed above in connection with FIG. 2, modifications to the project plan can be suggested by team members or potential team members prior to finalization of the plan. If a suggested modification impacts the composite risk, then the composite risk may be modified and the change, as well as the reason for the change may be flagged for the user.

The project application 116 can generate or be used to generate risk analytics. Risk analytics for a project model can be divided into categories such as global risks, detail strategy risks, operational risks, and team risks. Each category of risk may contribute to the composite risk. The project model defines the contributing risk factors for each risk, as well as how the risk impacts the composite risk.

Global risks can be defined by or otherwise correspond to organizational objectives for a company or other organization. Organizational objectives can be used to define a strategy for a project.

Detail strategy risks can be generated based on a response to an objective, task, strategy, or other criteria specified for a given project.

Operational risks can be risks associated with removing one or more tasks from a critical path of a project as specified in a project model. For example, a user or other entity may provide input to the project application 116 that removes one or more tasks from the critical path. Removing one or more tasks from the critical path can increase the risk of a negative impact on delivery of a desired outcome, such as a delay in the desired outcome or a failure to achieve the desired outcome.

Team risks can be risks associated with a selected team and/or selected members of a team. A project model can specify a relationship between attributes of one or more roles on the team and a risk associated with specific personnel selected to perform the roles. For example, a risk associated with a team member may correspond to a specified or desired seniority for a role performed by the team member. Reducing the specified or desired seniority for a role and/or assigning a team member with less than the specified or desired seniority can increase team risks for the project. Conversely, assigning a team member with seniority that is greater than or equal to the specified or desired seniority can reduce the team risks for the project. In some embodiments, the project application 116 can evaluate team risks against delivered results. Delivered results can be tracked by the project application 116 for the projects the team has worked on previously and the resulting outcome.

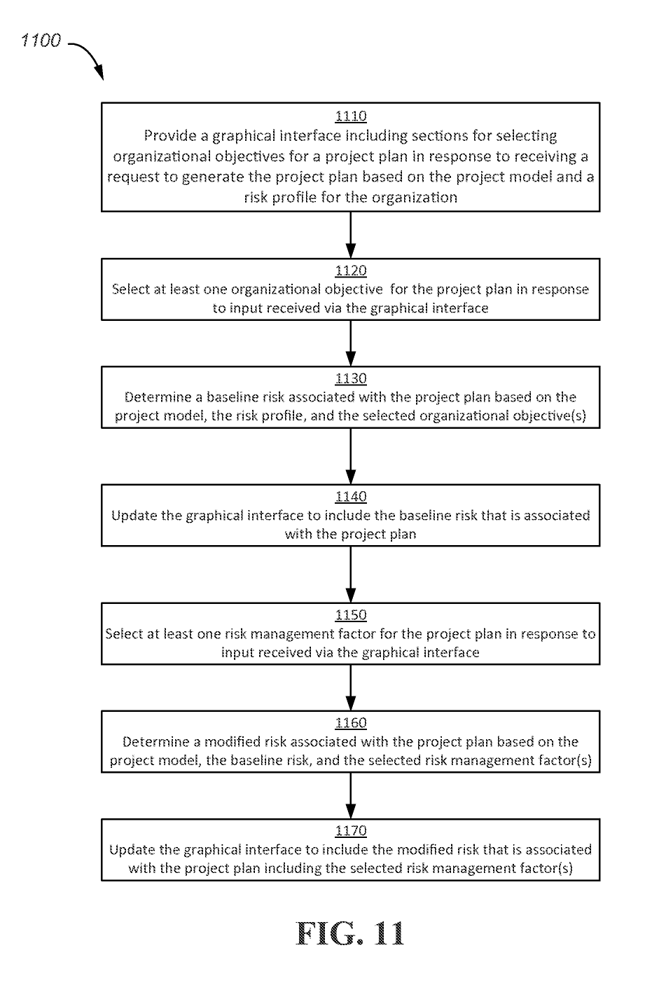

FIG. 11 is a flow chart illustrating an example method 1100 for obtaining risk information associated with a project plan generated from a project model. For illustrative purposes, the method 1100 is described with reference to the system implementation depicted in FIG. 1. Other implementations, however, are possible.

The method 1100 involves providing a graphical interface in response to receiving a request to generate a project plan, as depicted in block 1110. For example, the processing device 108 can execute the project application 116 to generate a graphical interface 300 in response to receiving a request to generate a project plan. The project plan can be generated based on a project model and a risk profile for the organization. The graphical interface 300 can include a section 302 for selecting organizational objectives and a section 308 for selecting risk management factors for the project plan. In additional or alternative aspects, the graphical interface can also include one or more of sections 304, 306, 310, 312, 314.

The method 1100 further involves selecting at least one organizational objective in response to input received via the graphical interface, as depicted in block 1120. For example, the processing device 108 can execute the project application 116 to receive one or more inputs to section 302 of the graphical interface 300 selecting one or more business or other organizational objectives, as described above with respect to FIG. 4. Selecting one or more organizational objectives can allow a user or other entity to generate a project plan for a selected project model based on selected objectives and other features of the project model identified as relevant to the user's project. The project application 116 can use a project model and the organization's profile to generate baseline data for the project plan and to create a full plan for teams involved in the project.

The method 1100 further involves determining a baseline risk associated with the project plan based on the project model, the risk profile and one or more organizational objects selected in response to the input received via the graphical interface, as depicted in block 1130. For example, the processing device 108 can execute the project application 116 to determine the baseline risk.

The project application 116 can use the project model to determine risks associated with organizational objectives and/or actions associated with the organizational objectives. For example, the project model can define multiple potential objectives for a project and respective actions or groups of actions associated with the organizational objectives. The libraries 104a-n can specify risks associated with the actions and/or the organizational objectives. The project application 116 can access one or more of the libraries 104a-n based on organizational objectives selected from the project model to determine a risk weight associated with the selected organizational objectives.

The project application 116 can also determine that the project type as specified in the project model (e.g., a specific type of legal matter) is identified as a risk in the risk profile for the organization. The project application 116 can determine a weight for the risk as specified in the risk profile. The project application 116 can apply the weight as specified in the risk profile to the project plan. For example, a risk profile item can be weighted as a percentage. The project application 116 can convert the percentage to a value used for a project plan. In a non-limiting example, a risk weighting percentage of 10% can correspond to a risk weight of 0.1, a risk weighting percentage of 50% can correspond to a risk weight of 0.5, etc. The project application 116 can determine the baseline matter risk by adding the risk weight determined from the risk profile to the risk weight determined for the selected organizational objectives.

The method 1100 further involves updating the graphical interface to include the baseline risk that is associated with the project plan, as depicted in block 1140. For example, the processing device 108 can execute the project application 116 to update the graphical interface 300 with the baseline risk. The baseline risk and/or a visual indicator for the baseline risk can be displayed in the graphical interface 300 at section 316. The project application 116 can thereby use the risk profile and the libraries 104a-n to provide information and guidance to a user via the graphical interface 300 regarding the baseline risk for a project plan generated from a project model.

The method 1100 further involves selecting at least one risk management factor in response to input received via the graphical interface, as depicted in block 1150. For example, the processing device 108 can execute the project application 116 to receive one or more inputs to section 302 of the graphical interface 300 that select one or more risk management factors, as described above with respect to FIG. 7.

The method 1100 further involves determining a modified risk for the project model based on the project model, the baseline risk, and the selected risk management factor(s), as depicted in block 1160. For example, the processing device 108 can execute the project application 116 to apply the selected risk management factors to the project plan to determine the modified risk. Non-limiting examples of risk management factors includes modifications to operations, teams, and budgets.

The method 1100 further involves updating the graphical interface to include the modified risk that is associated with the project plan including the selected risk management factors, as depicted in block 1170. For example, the processing device 108 can execute the project application 116 to update the graphical interface 300 with the composite risk. For example, selection of a risk management factor that decreases the risk associated with the project plan can cause the project application 116 to reduce the risk displayed in the section 316 of the graphical interface 300.

### GENERAL

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other storage devices, transmission devices, or display devices of the computing platform.

The system or systems discussed herein are not limited to any particular hardware architecture or configuration. A computing device can include any suitable arrangement of components that provide a result conditioned on one or more function calls. Suitable computing devices include multipurpose microprocessor-based computer systems accessing stored software that programs or configures the computing system from a general-purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method comprising:
providing a graphical interface in response to receiving a request to generate a project plan from a project model, wherein the graphical interface is generated based on the project model and comprises a first section for selecting organizational objectives for an organization and a second section for selecting risk management factors for the project plan;
selecting at least one organizational objective for the plan in response to input received via the graphical interface;
determining a baseline composite risk for the project plan using the project model, the selected at least one organizational objective, and a risk profile for the organization;
updating the graphical interface by updating a risk indicator to reflect the baseline composite risk associated with the project plan;
selecting at least one risk management factor for the plan in response to input received via the graphical interface;
determining a modified composite risk for the project plan using the project model, the baseline composite risk, and the selected at least one risk management factor; and
updating the graphical interface to update the risk indicator to reflect the modified composite risk,
wherein the composite risk indicator provides a relative measure of the risk associated with the project plan.

2. The method of claim 1, further comprising:
identifying a critical path for the project plan based on the project model;
receiving an input via the graphical interface removing at least one task from the critical path;
determining an additional risk associated with removing the at least one task from the critical path; and
updating the modified composite risk and the risk indicator based on the additional risk.

3. The method of claim 1, further comprising:
identifying, based on the project model, at least one attribute of a role for an entity assigned to perform at least one task for the project plan;
receiving an input via the graphical interface identifying the entity;
determining an additional risk associated with the entity performing the role in the project plan based on the entity lacking the at least one attribute; and
updating the modified composite risk based on the additional risk.

4. The method of claim 1, wherein the risk profile for the organization identifies a plurality of primary risks and a plurality of secondary risks and includes a weight for each of the primary risks and the secondary risks.

5. The method of claim 4, wherein determining a baseline composite risk comprises:
determining a project type for the project model;
determining that at least one of the primary risks or secondary risks of the risk profile corresponds to the project type; and
using the weighting in the risk profile for the at least one primary risk or secondary risk that corresponds to the project type to determine the baseline composite risk.

6. The method of claim 1, wherein the project model defines a plurality of risk management factors associated with each of the organizational objectives and a weight for each of the risk management factors associated with each of the organizational objectives.

7. The method of claim 1, wherein the project model is maintained in a library of project models and the project model uses information stored in a business objectives library and a risk management factors library.

8. The method of claim 1, further comprising:
determining a business attribute for the project plan using the project model, the selected at least one organizational objective, and a profile for the organization; and
updating the graphical interface to display the business attribute.

9. The method of claim 1, further comprising:
finalizing the project plan in response to input received via the graphical interface;
identifying a plurality of recipients of the plan in response to input received via the graphical interface;
sending the finalized project plan to the recipients;
receiving a suggested modification to the finalized project plan from one of the recipients; and
updating the graphical interface with information reflecting how the suggested modification affects the composite risk.

10. A system comprising:
a processing device; and
a non-transitory computer-readable medium communicatively coupled to the processing device,
wherein the processing device is configured for executing instructions stored in the non-transitory computer-readable medium to perform operations comprising:
providing a graphical interface in response to receiving a request to generate a project plan from a project model, wherein the graphical interface is generated based on the project model and comprises a first section for selecting organizational objectives for an organization and a second section for selecting risk management factors for the project plan;
selecting at least one organizational objective for the plan in response to input received via the graphical interface;
determining a baseline composite risk for the project plan using the project model, the selected at least one organizational objective, and a risk profile for the organization;
updating the graphical interface by updating a risk indicator to reflect the baseline composite risk associated with the project plan;
selecting at least one risk management factor for the plan in response to input received via the graphical interface;
determining a modified composite risk for the project plan using the project model, the baseline composite risk, and the selected at least one risk management factor; and
updating the graphical interface to update the risk indicator to reflect the modified composite risk,
wherein the composite risk indicator provides a relative measure of the risk associated with the project plan.

11. The system of claim 10, further comprising:
a memory device comprising a plurality of libraries, wherein the libraries include project model libraries, a business objective library, and a risk management factors library.

12. The system of claim 10, further comprising:
a network interface device for communicating across a network,
wherein the processing device is further configured to perform operations comprising:
finalizing the project plan in response to input received via the graphical interface;
identifying a plurality of recipients of the plan in response to input received via the graphical interface;
sending the finalized project plan to the recipients via the network interface device;
receiving a suggested modification to the finalized project plan from one of the recipients via the network interface device; and
updating the graphical interface with information reflecting how the suggested modification affects the composite risk.

13. The system of claim 10, further comprising:
a memory device comprising a repository,
wherein the processing device is further configured to perform operations comprising:
collecting data generated during execution of the project plan and execution of additional project plans generated from the project model; and
storing the collected data in the repository.

14. The system of claim 10, further comprising:
a memory device for storing the risk profile for the organization, wherein the risk profile identifies a plurality of primary risks and a plurality of secondary risks and includes a weight for each of the primary risks and the secondary risks.

15. The system of claim 10, further comprising:
a memory device for storing a profile for the organization,
wherein the processing device is further configured to perform operations comprising:
determining a business attribute for the project plan using the project model, the selected at least one organizational objective, and the profile for the organization; and
updating the graphical interface to display the business attribute.
